(19) United States
(12) Patent Application Publication
(10) Pub. No.: US 2010/0010723 A1
(43) Pub. Date: Jan. 14, 2010

(54) VEHICLE CONTROL DEVICE AND CONTROL METHOD THEREFOR

(76) Inventors: Naoki Taki, Okazaki-shi (JP); Koki Moriya, Toyota-shi (JP)

Correspondence Address: KENYON & KENYON LLP, 1500 K STREET N.W., SUITE 700, WASHINGTON, DC, 20005, US

(21) Appl. No.: 12/376,142

(22) PCT Filed: Nov. 13, 2007
(86) PCT No.: PCT/IB2007/003474

§ 371 Date: Feb. 3, 2009

(30) Foreign Application Priority Data
Nov. 13, 2006 (JP) 2006-307030

(51) Int. Cl. F02D 45/00; G06F 19/00

(52) U.S. Cl. 701/102; 701/301

(57) ABSTRACT

A vehicle control device including an eco-run control system for automatically stopping the engine under a predetermined condition when the vehicle is stopped and starting the engine under a predetermined restart condition further includes a vehicle surroundings monitoring device that detects a possibility of the vehicle being collided with by another vehicle. When the vehicle surroundings monitoring device detects a possibility of collision while the engine is kept in a stop mode because of eco-run control and when starting the engine will provide a benefit (when there is a possibility of avoiding a collision), the engine is immediately started to give the driver an opportunity to avoid the collision and a PCS device is activated in preparation for the collision. When the collision is inevitable, only the PCS device is activated.

### BACKGROUND OF THE INVENTION

1. Field of the Invention

The present invention relates to a vehicle control device applicable to a vehicle provided with an eco-run control system and a control method therefor. More specifically, the present invention relates to a vehicle control device which starts the engine of the vehicle immediately to increase the chance to avoid a collision when a possibility of the vehicle being collided with by another vehicle is predicted while its engine is in a shut-off mode because of eco-run control, and a control method therefor.

2. Description of the Related Art

Various types of control devices for a vehicle (motorcar) which perform what is called eco-run (economical & ecological running) control, in other words, automatically stop and start the engine of the vehicle under a predetermined condition, have been conventionally provided for the purpose of fuel saving and emission reduction.

For example, there are vehicles provided with an automatic engine stopping/starting device which automatically shuts off the engine under a predetermined condition when the vehicle is stopped, for example, at a red light at an intersection and then restarts the engine under a predetermined restart condition (for example, when the accelerator pedal is depressed) (see Japanese Patent Application Publication No. 10-318010 (JP-A-10-318010), Japanese Patent Application Publication No. 2005-23839 (JP-A-2005-23839) and Japanese Patent Application Publication No. 2000-45819 (JP-A-2000-45819), for example).

In recent years, with regard to control of a vehicle such as a motorcar, development of a control technology to evade a collision with an object in front of the subject vehicle is proceeding. As such a control, a technology for preventing or avoiding a collision with an object ahead, for example, is provided. Also provided is a technology for protecting the passengers on the assumption that a collision with an object ahead will occur.

One well-known example of the former is what they call ACC (Auto-Cruise-Control or Adaptive-Cruise-Control) control. The ACC control is a control to adjust the output of the engine or the like to cause the subject vehicle to follow the preceding vehicle in the relative state with the subject vehicle.

One well-known example of the latter is what they call PCS (Pre-Crash-Safety) control. The PCS control is a control to predict a collision of a vehicle and activate a passenger protection device (which is hereinafter referred to as “PCS device”) such as seat belt device, seat device or head rest device before the collision to protect the passengers.

As described above, a vehicle provided with an eco-run control system temporarily shuts off the engine at a red light at an intersection and other occasions. When the driver acknowledges a possibility of being collided with by a vehicle behind or a collision prediction device of the vehicle predicts a collision while the engine is in a shut-off mode, the driver should start the engine and take necessary measures immediately to avoid the collision.

However, it takes about one second until the engine is actually started after a normal eco-run restart condition is satisfied (for example, after the driver depresses the accelerator pedal). Thus, even if the driver acknowledges a possibility of collision while the engine is in a shut-off mode, the vehicle may be started immediately to avoid a collision and may be collided with before the engine is started.

Also, the PCS devices are designed on the basis that it is activated when the engine is started up and usually require a large amount of electric power to activate. Thus, in a vehicle provided with a PCS device, when the PCS device is activated while the engine is in a shut-off mode because of eco-run control, it may not be activated properly because of electric power shortage if the charge level of the battery is too low.

### SUMMARY OF THE INVENTION

The present invention provides a vehicle control device which starts the engine immediately to increase the opportunity to avoid a collision when a possibility of being collided with by another vehicle is predicted while the engine is kept in a stop-off mode because of eco-run control, and a control method therefor.

A control device for a vehicle according to a first aspect of the present invention includes: an automatic engine stopping/starting device that automatically stops the engine under a predetermined condition when the vehicle is stopped and starts the engine under a predetermined restart condition; and a collision possibility detection means for detecting a possibility of the vehicle being collided with by another vehicle, wherein, when the collision possibility detecting means detects a possibility of collision while the engine is kept in a stop mode by the automatic engine stopping/starting device, the automatic engine stopping/starting device cancels the engine stop mode and starts the engine.

A second aspect of the present invention provides the control device according to the first aspect, further including: a passenger protection device that protects passengers of the vehicle from the collision, wherein, when the collision possibility detection means detects a possibility of collision while the engine is kept in a stop mode by the automatic engine stopping/starting device, the stop mode of the engine effected by the automatic engine stopping/starting device is cancelled to start the engine and the passenger protection device is activated.

A third aspect of the present invention provides the control device according to the second aspect, further including: a collision avoidance possibility determination means for determining whether there is a possibility of being able to avoid the collision by starting the engine, wherein, when the collision possibility detection means detects a possibility of collision while the engine is kept in a stop mode by the automatic engine stopping/starting device, the engine is started and the passenger protection device is activated when the collision avoidance possibility determination means determines that there is a possibility of being able to avoid the collision, and the passenger protection device is activated without starting the engine when the collision avoidance possibility determination means determines that there is no possibility of being able to avoid the collision.

A fourth aspect of the present invention provides the control device according to the third aspect, further including: an advancing appropriateness determination means for determining whether moving subject vehicle forward to avoid the collision is appropriate; a vehicle stationary state retaining device that retains the vehicle in a stationary state; and an automatic following distance control device that controls the running conditions of the vehicle depending on the distance to a preceding vehicle, wherein, when the advancing appropriateness determination means determines that moving the vehicle forward is appropriate after the automatic engine stopping/starting device starts the engine, the vehicle stationary state retaining device cancels retention of the stationary state of the vehicle, and the automatic following distance control device causes the vehicle to follow the preceding vehicle.

A fifth aspect of the present invention provides a control method for a vehicle wherein the vehicle including: an automatic engine stopping/starting device that automatically stops the engine under a predetermined condition when the vehicle is stopped and starts the engine under a predetermined restart condition; and a collision possibility detection means for detecting a possibility of the vehicle being collided with by another vehicle, the control method includes cancelling a stop mode of the engine effected by the automatic engine stopping/starting device and starting the engine when the collision possibility detection means detects a possibility of collision while the engine is kept in a stop mode by the automatic engine stopping/starting device.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a flowchart illustrating a control method for a vehicle control device according to a first embodiment of the present invention;

FIG. 2 is a block diagram of the vehicle control device;

FIG. 3 is a block diagram of a vehicle control device according to a second embodiment of the present invention; and

FIG. 4 is a flowchart illustrating a control method according to the second embodiment of the present invention.

### DETAILED DESCRIPTION OF EMBODIMENTS

Description is hereinafter made of embodiments of the vehicle control device according to the present invention in detail with reference to the drawings. The embodiments are not intended to limit the present invention.

### First Embodiment

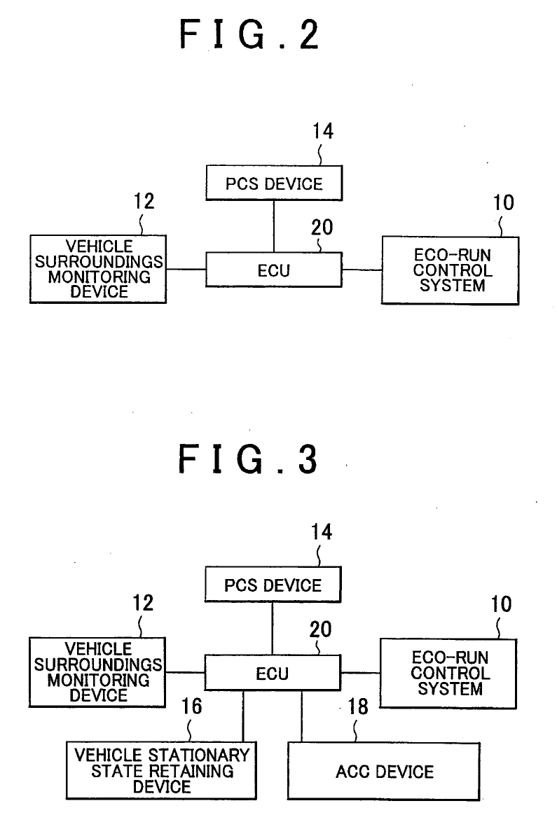

FIG. 2 is a block diagram of the vehicle control device. While description is made on the assumption that the subject vehicle is collided with from behind by another vehicle in the following embodiments, the present invention is not limited to thereto. As shown in FIG. 2, an eco-run control system (automatic engine stopping/starting device) 10 outputs an engine stop command signal for performing eco-run control and an engine restart command signal for restarting the engine to an engine ECU (not shown) based on an instruction from an ECU 20, which is described later.

The engine restart control, which is performed when it is determined that the driver is inclined to drive the vehicle based on the depression of the accelerator pedal during normal eco-run control, is performed when the ECU 20 determines it necessary irrespective of the driver's driving intention in this first embodiment as described later. Then, the engine ECU outputs control signals for controlling the fuel injection, air intake, ignition and so on to the engine.

In the engine restart control, an engine restart command signal is outputted from the eco-run control system 10 to the engine ECU and a starter control signal is outputted to a starter (not shown). Then, the engine ECU outputs the control signals for controlling the fuel injection, air intake, ignition and so on to the engine in synchronization with the timing of driving the starter to restart the engine.

A vehicle surroundings monitoring device (collision possibility detection means) 12 is a well-known device for detecting or calculating the distances and relative speeds to the vehicles ahead and behind, for example. As a detection means for use in the vehicle surroundings monitoring device 12, various types of sensors capable of detecting obstacles around the subject vehicle which may collide with it may be adopted. For example, a millimeter wave sensor or camera (monocular or multiocular camera) may be used. The detected or calculated information is outputted to the ECU 20, which is described later.

A PCS device (passenger protection device) 14 is a well-known device such as a seat belt device, seat device and head rest device which is activated to protect the passenger when the vehicle is predicted to collide with an external object. if appropriate measures are taken against an impending collision when a collision is predicted, the passenger can be protected more effectively.

One example of the PCS device 14 is a seat belt device having a pre-tensioner that takes the slack out of the seat belt with a motor or the like in preparation for a collision when a collision is predicted.

A seat device as the PCS device 14 activates a motor or the like to return the position and angle of the seat to the normal state. For example, if the seat is positioned either too far ahead or behind when a collision is predicted, the seat device returns the seat to the normal position in preparation for a collision to protect the passenger.

A head rest device as the PCS device 14 is configured to move the head rest forward or backward to control the distance between the head of the occupant and the head rest. Thus, when the vehicle is predicted to be collided with from behind, the head rest is moved closer to the occupant a predetermined time period before the collision (for example, one second before the collision) so that the strain which may be exerted on the neck of the occupant when the upper body of the occupant falls backward can be reduced.

The ECU (vehicle control device) 20 as an electronic control device also functions as a collision avoidance possibility determination means for determining whether there is a possibility of being able to avoid a collision by starting the engine based on information from the vehicle surroundings monitoring device 12 and functions to start the engine or activate the PCS device 14 via the eco-run control system 10 based on the determination result as well as performs basic vehicle control functions.

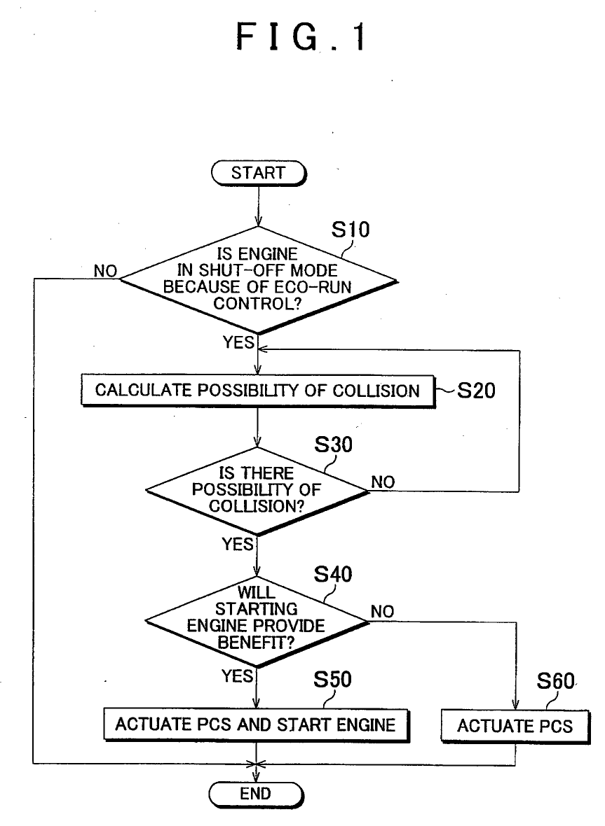

The control method is next described with reference to FIG. 1. FIG. 1 is a flowchart illustrating a control method for a vehicle control device according to a first embodiment of the present invention. The control described below is performed by the ECU 20.

As shown in FIG. 1, it is first determined whether the engine is kept in a shut-off mode by the eco-run control system 10 (step S10). If the engine is not in a shut-off mode (negative in step S10), the control is ended since this control is not required. If the engine is in a shut-off mode (affirmative in step S10), the possibility of the subject vehicle being collided with is calculated based on the detected information from the vehicle surroundings monitoring device 12 (step S20).

The possibility of being collided with is estimated and calculated as a period of time until the subject vehicle is collided with (which is hereinafter referred to as TTC: Time To Collision) based on the information (such as the distance and relative speed to the vehicle behind) from the vehicle surroundings monitoring device 12.

Then, it is determined from the TTC value whether there is a possibility of being collided with (step S30). If there is no possibility of being collided with (negative in step S30), the possibility of the subject vehicle being collided with is continuously calculated based on the detected information from the vehicle surroundings monitoring device 12 (step S20). If there is a possibility of being collided with (affirmative in step S30), it is determined whether or not starting the engine with the eco-run control system 10 will provide a benefit (step S40).

That is, if the TTC is at least 2 to 3 seconds, for example, it is possible to increase the opportunity for the driver to start the subject vehicle and move it to a safe place immediately by starting the engine even if the driver does not depress the accelerator pedal. Therefore, it is determined that starting the engine will provide a benefit (affirmative in step S40).

In such a case, the PCS device 14 is activated in preparation for the collision to protect the passengers and the driver is immediately warned of an impending collision. At the same time, the engine is started to urge the driver to move the vehicle to avoid a collision (step S50). That is, when a possibility of the subject vehicle being collided with by another vehicle is predicted while the engine is in a shut-off mode because of eco-run control, the engine is immediately started to give the driver an opportunity to avoid the collision.

In addition, as the engine is started, it is possible to supply a large amount of electric power momentarily necessary to activate the PCS device 14. Thus, the possibility of malfunction of the PCS device 14 due to shortage of electric power can be reduced even if the amount of charge in the battery is insufficient.

On the other hand, if the TTC is not longer than 1 second, even if the engine is started, it is substantially impossible for the driver to move the subject vehicle to a safe place in such a short period of time. Thus, it is determined that starting the engine will not provide a benefit (negative in step S40).

In such a case, the driver is immediately warned of an impending collision, and the PCS device 14 is activated (step S60), without starting the engine, in preparation for the collision to protect the passengers. In a vehicle which is not provided with a PCS device, the only thing to be done in step S60 may be not to allow the engine to be started.

When it is almost certain that the subject vehicle will be collided with as above, the risk of a fire caused by the collision can be further reduced by not allowing the engine to be started. That is, when it is determined that there is no possibility of being able to avoid a collision, the passenger protection device is activated without starting the engine to further reduce the risk of a fire caused by the collision and to protect the passengers.

The warning may be made by alarm sound or alarm voice sound in combination with display on the instrumental panel in front of the driver's seat.

As described above, according to the vehicle control device of the first embodiment, when a possibility of being collided with by another vehicle is predicted while the engine is in a shut-off mode because of eco-run control, the engine is immediately started to give the driver an opportunity to avoid a collision. Even if a collision is inevitable, it is possible to reduce damage resulting from the collision to protect the passengers.

### Second Embodiment

While the engine is immediately started to increase the opportunity for the driver to move the vehicle by him- or herself to avoid a collision in the first embodiment, retention of a stationary state of the vehicle is automatically cancelled and the vehicle is immediately started and accelerated irrespective of the driver's intention to increase the opportunity to avoid being collided with from behind in a second embodiment.

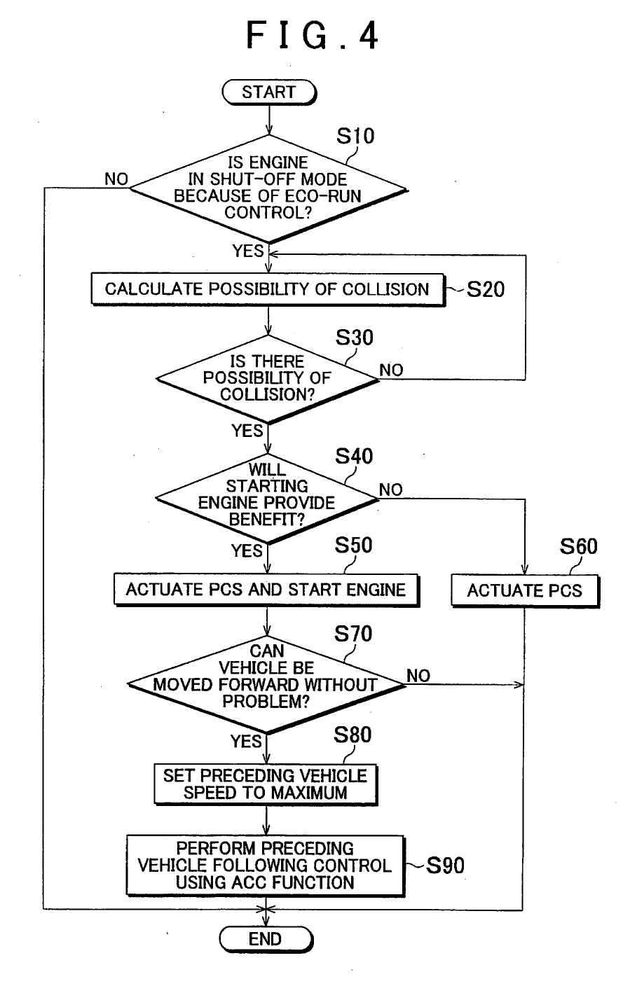

FIG. 3 is a block diagram of a vehicle control device according to the second embodiment of the present invention, and FIG. 4 is a flowchart illustrating a control method according to the second embodiment. In the following description, component parts and steps equivalent to or corresponding to those which have been described before are denoted by the same reference numerals and redundant description is omitted or simplified.

As shown in FIG. 3, a vehicle stationary state retaining device 16 for retaining the vehicle in a stationary state, which is a well-known motor-operated parking brake device, is configured to be operated according to the intention of the driver in response to switch operation by the driver and to be switched between a braking state and a non-braking state depending on the state of the vehicle.

The vehicle stationary state retaining device 16 can automatically bring the parking brake into a braking state when, for example, the vehicle is in a stationary state for a predetermined period of time and automatically release the parking brake in response to a release instruction from the ECU 20 or on detecting the shift of the shift lever into the drive range.

An ACC device 18, which is a well-known automatic following distance control device for controlling the running conditions of the subject vehicle depending on the distance to the vehicle ahead, is known as a device which detects the distance to the preceding vehicle with the vehicle surroundings monitoring device 12 and controls the running conditions of the subject vehicle based on the distance to cause the subject vehicle to follow the preceding vehicle.

That is, the ACC device 18 performs acceleration control when the distance to the preceding vehicle detected by the vehicle surroundings monitoring device 12 is longer than a predetermined following distance for determination and performs a deceleration control when the distance to the preceding vehicle detected by the vehicle surroundings monitoring device 12 is shorter than the predetermined following distance for determination in order to always maintain a proper following distance.

Also, the ACC device 18 sets a driving force and a braking force to be generated during the acceleration control and deceleration control based on the following distance, for example. The ACC device 18 controls to generate large driving force when the following distance becomes unnecessarily large and large braking force when the following distance becomes too small.

As a result, even if the following distance increases or decreases from an appropriate value, the driving force or braking force is changed as needed depending on the condition to maintain a proper following distance.

Therefore, when the preceding vehicle repeatedly starts and stops in a traffic congestion, for example, the subject vehicle controls the vehicle speed and repeatedly starts and stops to adjust the actual following distance to the determining following distance, whereby automatic driving (which is abbreviated as “ACC” function in FIG. 4, which is described later) is achieved.

In this second embodiment, when the subject vehicle is predicted to be collided with by a vehicle from behind while the engine is in a shut-off mode because of eco-run control and when the collision may be avoided if the subject vehicle is moved forward, the parking brake held by the vehicle stationary state retaining device 16 is released and the automatic driving function of the ACC device 18 is used to start and accelerate the subject vehicle immediately in order to avoid the collision or reduce the damage resulting from the collision as described later.

The ECU 20 has a function as an advancing appropriateness determination means for determining whether the vehicle can be moved forward to avoid a collision in addition to the functions described in the first embodiment.

That is, as shown in step S70 and later steps in FIG. 4, when the ECU 20 determines that the distance to the vehicle ahead. is equal to or greater than a predetermined value and the vehicle can be moved forward safely based on the detected information from the vehicle surroundings monitoring device 12 (affirmative in step S70), the parking brake held by the vehicle stationary state retaining device 16 is released (not shown), the speed of the preceding vehicle (the vehicle ahead) is set to a maximum value (100 km/h, for example) (step S80), and a preceding vehicle following control using the ACC device 18 is performed (step S90). Then, the subject vehicle can be started and accelerated immediately.

As a result, the possibility of being able to avoid a collision can be enhanced. Even if a collision is inevitable, since the subject vehicle is moving forward at the time of collision and the relative speed to the vehicle behind is reduced, the energy of collision can be reduced to minimize the damage. That is, retention of a stationary state of the vehicle is cancelled irrespective of the driver's intention, and the automatic following distance control device is used to start and accelerate the vehicle immediately in order to increase the chance to avoid being collided with from behind.

At the time of collision, the passengers are protected by the PCS device 14, which has been already activated in step S50. When the vehicle cannot be moved forward safely (negative in step S70), the preceding vehicle following control using the ACC device 18 is not performed and the control is ended.

As described above, according to the vehicle control device of the second embodiment, when the subject vehicle is predicted to be collided with by a vehicle from behind while the engine is in a shut-off mode because of eco-run control and when there is a possibility of being able to avoid the collision by moving the vehicle forward, the parking brake held by the vehicle stationary state retaining device 16 is released and automatic driving function of the ACC device 18 is used to start and accelerate the subject vehicle immediately in order to avoid a collision or to reduce the damage resulting from the collision.

While description is made on the basis that it is determined whether or not the subject vehicle can be moved forward safely based on detected information from the vehicle surroundings monitoring device 12 in the second embodiment, the present invention is not limited thereto. For example, when infrastructural information about whether the vehicle is at a signalized intersection and so on is taken into account in addition to the detected information, a more effective determination necessary to improve the safety can be made.

Also, while description is made on the basis that it is determined whether the vehicle can be moved forward in step S70, the term “forward” herein includes diagonally to the right and left as well as right ahead of the subject vehicle. When the ACC device 18 performs the preceding vehicle following control, the steering wheel may be automatically controlled to a safer direction when necessary. In addition, if the ECU 20 determines that the distance to a vehicle in a direction in which the subject vehicle can be moved to avoid collision (collision avoidable preceding vehicle) is equal to or greater than a predetermined distance and the vehicle can be started safely in the direction to avoid a collision based on detected information from the vehicle surroundings monitoring device 12 in step 70, the speed of the collision avoidable preceding vehicle may be set to a maximum value (100 km/h, for example) and the following control using the ACC device 18 may be performed.

While description is made on the assumption that the subject vehicle is collided with by another vehicle from behind in the first embodiment and the second embodiment, the present invention is not limited thereto. For example, the present invention may be applied to a collision from front or side and provide the same effects.

1-12. (canceled)

13. A control device for a vehicle comprising:
an automatic engine stopping/starting device that automatically stops the engine under a predetermined condition when the vehicle is stopped and starting the engine under a predetermined restart condition; and
a collision possibility detection device that detects a possibility of the vehicle being collided with by another vehicle, wherein, when the collision possibility detecting device detects a possibility of collision while the engine is kept in a stop mode by the automatic engine stopping/starting device, the automatic engine stopping/starting device cancels the engine stop mode and starts the engine.

14. The control device according to claim 13, further including: a passenger protection device that protects passengers of the vehicle from the collision, wherein, when the collision possibility detection device detects a possibility of collision while the engine is kept in a stop mode by the automatic engine stopping/starting device, the stop mode of the engine effected by the automatic engine stopping/starting device is cancelled to start the engine and the passenger protection device is activated.

15. The control device according to claim 14, further including: a collision avoidance possibility determination device that determines whether there is a possibility of being able to avoid the collision by starting the engine, wherein, when the collision possibility detection device detects a possibility of collision while the engine is kept in a stop mode by the automatic engine stopping/starting device, the engine is started and the passenger protection device is activated when the collision avoidance possibility determination device determines that there is a possibility of being able to avoid the collision, and the passenger protection device is activated without starting the engine when the collision avoidance possibility determination device determines that there is no possibility of being able to avoid the collision.

16. The control device according to claim 13, further including: a collision avoidance possibility determination device that determines whether there is a possibility of being able to avoid the collision by starting the engine, wherein, when the collision avoidance possibility determination device determines that there is no possibility of being able to avoid the collision, the automatic engine stopping/starting device does not start the engine.

17. The control device according to claim 15, further including: an advancing appropriateness determination device that determines whether moving the subject vehicle forward to avoid the collision is appropriate; a vehicle stationary state retaining device that retains the vehicle in a stationary state; and an automatic following distance control device that controls the running conditions of the vehicle depending on the distance to a preceding vehicle, wherein, when the advancing appropriateness determination device determines that moving the subject vehicle forward is appropriate after the automatic engine stopping/starting device starts the engine, the vehicle stationary state retaining device cancels retention of the stationary state of the vehicle, and the automatic following distance control device causes the vehicle to follow the preceding vehicle.

18. The control device according to claim 13, further including: a running appropriateness determination device that determines whether moving the subject vehicle in a direction in which the subject vehicle is moved to avoid the collision is appropriate; an automatic following distance control device that controls the running conditions of the vehicle depending on the distance to another vehicle, wherein, when the running appropriateness determination device determines that moving the subject vehicle in the direction to avoid the collision is appropriate after the automatic engine stopping/starting device starts the engine, the automatic following distance control device causes the subject vehicle to follow another vehicle in the direction.

19. A control method for a vehicle wherein the vehicle includes: an automatic engine stopping/starting device that automatically stops an engine under a predetermined condition when the vehicle is stopped and starts the engine under a predetermined restart condition; and a collision possibility detection device that detects a possibility of the vehicle being collided with by another vehicle, the control method comprising:
cancelling a stop mode of the engine effected by the automatic engine stopping/starting device and starting the engine when the collision possibility detection device detects a possibility of collision while the engine is kept in a stop mode by the automatic engine stopping/starting device.

20. The control method according to claim 19, wherein, when the collision possibility detection device detects a possibility of collision while the engine is kept in a stop mode by the automatic engine stopping/starting device, the stop mode of the engine effected by the automatic engine stopping/starting device is cancelled to start the engine and a passenger protection device that protects passengers of the vehicle from the collision is activated.

21. The control method according to claim 20, wherein, when the collision possibility detection device detects a possibility of collision while the engine is kept in a stop mode by the automatic engine stopping/starting device, the engine is started and the passenger protection device is activated when there is a possibility of being able to avoid the collision, and the passenger protection device is activated without starting the engine when there is no possibility of being able to avoid the collision.

22. The control method according to claim 19, wherein the engine is not started when there is no possibility of being able to avoid the collision.

23. The control method according to claim 21, further comprising:
determining whether moving the subject vehicle forward is appropriate after the engine is started by the automatic engine stopping/starting device; and
cancelling retention of a stationary state of the vehicle and causing the vehicle to follow a preceding vehicle when it is determined that moving the subject vehicle forward is appropriate.

24. The control method according to claim 19, further comprising:
determining whether moving the subject vehicle in a direction in which the subject vehicle is moved to avoid the collision is appropriate after the engine is started by the automatic engine stopping/starting device; and
causing the subject vehicle to follow another vehicle in the direction when it is determined moving the subject vehicle in the direction is appropriate.
